(19) United States
(12) Patent Application Publication
(10) Pub. No.: US 2007/0169979 A1
(43) Pub. Date: Jul. 26, 2007

(54) Seatbelt position adjuster and inflatable vehicle occupant protection device slider

(75) Inventor: Masood A. Mohammad, Rochester, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/339,125

(22) Filed: Jan. 25, 2006

(51) Int. Cl. B60R 21/00; B60R 22/06

(52) U.S. Cl. 180/268; 280/804

(57) ABSTRACT

An apparatus (10) for a vehicle (12) having a seatbelt (100) and an inflatable vehicle occupant protection device (14) includes a track (152) connectable with the vehicle. A protection device anchor (60) helps maintain the position of the inflatable vehicle occupant protection device (14) while inflated. The protection device anchor (120) is movable along the track (152) in response to deployment of the inflatable vehicle occupant protection device (14). A seatbelt position adjuster (120) is associated with the seatbelt (100) and movable along the track (152) to adjust a height of the seatbelt.

### FIELD OF THE INVENTION

The present invention relates to apparatuses, such as seatbelts and inflatable vehicle occupant protection devices, that help protect vehicle occupants.

### BACKGROUND OF THE INVENTION

There are various known apparatuses for helping to protect occupants of a vehicle. For example, it is known to inflate an inflatable vehicle occupant protection device to help protect a vehicle occupant in the event of a vehicle collision. One particular inflatable vehicle occupant protection device is an inflatable curtain inflatable away from a vehicle roof to a position between a side structure of the vehicle and the vehicle occupant. As another example, it is known to provide a seatbelt for helping to secure or restrain an occupant in a vehicle.

### SUMMARY OF THE INVENTION

The present invention relates to an apparatus for a vehicle that has a seatbelt and an inflatable vehicle occupant protection device. The apparatus includes a track connectable with the vehicle. A protection device anchor helps maintain the position of the inflatable vehicle occupant protection device while inflated. The protection device anchor is movable along the track in response to deployment of the inflatable vehicle occupant protection device. A seatbelt position adjuster is associated with the seatbelt and movable along the track to adjust a position of a portion of the seatbelt.

The present invention also relates to an apparatus for a vehicle having a seatbelt and an inflatable vehicle occupant protection device. The apparatus includes-a track connectable with the vehicle and a first element movable along the track. The first element is adapted to engage the track to help limit movement of the inflatable vehicle occupant protection device relative to the vehicle. The apparatus also includes a second element movable along the track and adapted to engage the track to help fix the height of the seatbelt.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic view of an apparatus for helping to protect an occupant of a vehicle according to the present invention;

FIG. 2A is an enlarged view of a portion of the apparatus, according to a first embodiment of the present invention;

FIG. 2B is a sectional view of the apparatus taken generally along line 2B-2B in FIG. 2A;

FIG. 2C is a sectional view of the apparatus taken generally along line 2C-2C in FIG. 2A; and

FIG. 3 is an enlarged view of a portion of the apparatus, according to a second embodiment of the present invention.

### DESCRIPTION OF EMBODIMENTS

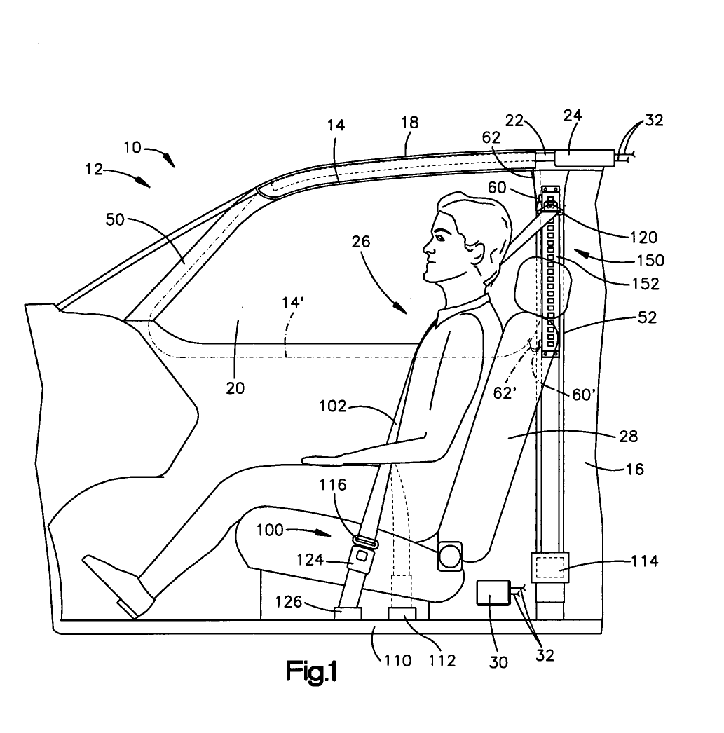

As representative of the present invention, an apparatus 10 helps to protect an occupant 26 of a vehicle 12. As shown in FIG. 1, the vehicle 12 includes an inflatable vehicle occupant protection device in the form of an inflatable curtain 14. The vehicle 12 also includes a seatbelt 100 for helping to secure or restrain the occupant 26 in a seat 28 of the vehicle. In FIG. 1, the apparatus 10 is illustrated as being installed on a passenger side of the vehicle 12. The apparatus 10 could, however, be installed on a driver side of the vehicle 12.

The inflatable curtain 14 is mounted adjacent the side structure 16 of the vehicle 12 and a roof 18 of the vehicle. The roof 18 may be either a standard roof that is fixed in place or a convertible roof that can be moved or removed. The side structure 16 of the vehicle 12 includes side windows 20. An inflator 24 is connected in fluid communication with the inflatable curtain 14 by known means, such as a fill tube 22. The inflatable curtain 14 is inflatable from a deflated and stored position indicated at 14 to an inflated and deployed position indicated at 14′.

The vehicle 12 includes a sensor mechanism 30 (shown schematically in FIG. 1) for sensing an event for which inflation of the inflatable curtain 14 is desired, such as a side impact to the vehicle 12 and/or a rollover of the vehicle. Upon sensing such an event, the sensor mechanism 30 provides an electrical signal over lead wires 32 to the inflator 24. The electrical signal causes the inflator 24 to be actuated in a known manner. The inflator 24 discharges fluid under pressure into the inflatable curtain 14 in a known manner.

The inflatable curtain 14 inflates under the pressure of the inflation fluid from the inflator 24. The inflatable curtain 14 inflates and deploys away from the roof 18 in a downward direction as shown in the drawings and in a downward direction with respect to the direction of forward travel of the vehicle 12 into the inflated and deployed condition illustrated at 14′.

The inflatable curtain 14, when inflated, extends along the side structure 16 of the vehicle 12 and is positioned between the side structure and the occupant 26 of the vehicle seat 28. The inflatable curtain 14 extends between an A pillar 50 and a B pillar 52 of the vehicle 12 and may overlie portions of the A pillar and B pillar.

As shown in FIG. 1, the inflatable curtain 14 may be connected to a protection device anchor or curtain anchor 60 either directly or via a tether 62. As shown at 60′ and 62′, respectively, the curtain anchor and tether help maintain the inflatable curtain 14 in the inflated and deployed position. The curtain anchor 60 also helps to limit movement of the inflatable curtain 14 away from the inflated and deployed position illustrated in FIG. 1.

Those skilled in the art will recognize that the inflatable curtain may have alternative configurations. For example, the inflatable curtain 14 could extend between the A pillar 50 and a C pillar (not shown) or between the B pillar and C pillar. Also, in a vehicle (not shown) having a D-pillar, the inflatable curtain 14 could extend to and cover a portion of the D pillar.

The seatbelt 100 includes a length of seat belt webbing 102 extensible about the vehicle occupant 28. One end of the seat belt webbing 102 is anchored to the vehicle body 110 at an anchor point 112 located on one side of the seat 28. The opposite end of the seat belt webbing 102 is attached to a retractor 114, which may be secured to the vehicle body 110 on the same side of the seat 28 as the anchor point 112.

Intermediate its ends, the seatbelt webbing 102 passes through a tongue assembly 116 and a position adjuster 120 that is located above the retractor 114 and the anchor point 112. When the seatbelt 100 is not in use, the seat belt webbing 102 is wound on the retractor 114, as known in the art. To use the seat belt 100, the tongue assembly 116 is moved across the seat 28 and connected with a buckle 124. The buckle 124 is connected to the vehicle body 110 on a side of the seat 28 opposite the anchor point 112 by an anchor plate 126.

According to the present invention, the apparatus 10 also includes a track assembly 150 that supports the seatbelt position adjuster 120 and the curtain anchor 60. The track assembly 150 includes a track 152 connectable to the vehicle 12. In the embodiment illustrated in FIG. 1, the track 152 is mounted to the B pillar 52 of the vehicle 12. As described below, the seatbelt position adjuster 120 and the curtain anchor 60 are connected to the track 152 and are adapted for sliding movement along the track.

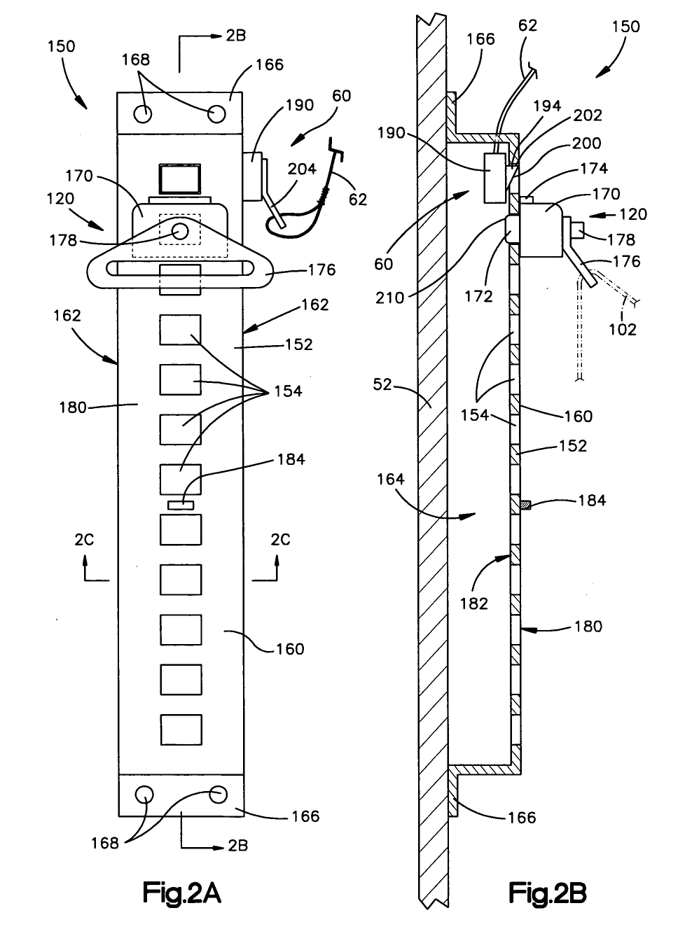

Referring to FIGS. 2A and 2B, the track 152 has a generally elongated configuration and may be formed using any suitable means of construction. In the embodiment of FIGS. 2A and 2B, the track 152 is constructed of a single elongated piece of material, such as metal, that is bent, cut, stamped, machined, or otherwise formed into the illustrated configuration. The track 152 has a plurality of apertures 154 spaced along its length.

The track 152 includes a main wall 160 and opposite side walls 162 that help define a channel 164 that extends along the length of the track. The track 152 also includes flange portions 166 at opposite ends of the main wall 160. The flange portions 166 include apertures 168 through which fastening means (not shown), such as bolts or screws, may extend to secure the track 152 to the vehicle 12.

The seatbelt position adjuster 120 includes a body portion 170 that is secured to the track 152 and adapted for sliding movement along the length of the track. The sliding relationship between the position adjuster 120 and the track 152 may be achieved by any known manner. For example, referring to FIG. 2C, the track 152 may include slots 186 that extend along the length of the track. In this example, the body portion 170 may have portions (not shown) that extend into or through the slots 186 and thereby support the position adjuster 120 for sliding movement along the track 152.

The position adjuster 120, track 152, or both may be fitted with bearing surfaces that facilitate a smooth sliding engagement between the position adjuster and track. As shown in FIG. 2A, the body portion 170 may be positioned for sliding movement on an outer surface 180 of the track 152. Alternatively, the body portion 170 could be positioned for sliding movement on an inner surface 182 of the track 152.

The position adjuster 120 also includes a latch element or member 172 (FIG. 2B) that protrudes from a surface of the body portion 170 facing the outer surface 180 of the track 152. The latch member 172 is biased to the position shown in FIG. 2B by means (not shown), such as a spring. The latch member 172 is retractable into the body portion 170 in a known manner through the manual actuation of a release mechanism 174, such as a pushbutton or lever.

The position adjuster 120 further includes a seatbelt D-ring or turning loop 176 through which the seatbelt webbing 102 extends. The seatbelt D-ring 176 is connected to the body portion 170 by fastening means 178, such as a bolt. The seatbelt D-ring 176 may be pivotable or rotatable relative to the body portion 170.

The seatbelt position adjuster 120 allows for adjusting the position of the seatbelt D-ring 176 in the vehicle 12 and, thus, the position at which the seatbelt webbing 102 passes through the D-ring. The seatbelt position adjuster 120 thus can be used to adjust the height, positioning, and path along which the seatbelt webbing 102 extends. The position adjuster 120 thereby allows for configuring the seatbelt 100 to accommodate occupants of different sizes. For example, relatively tall or large occupants may desire or require that the position adjuster 120 and D-ring 176 be adjusted to a high position in the vehicle 12. Conversely, relatively small or short occupants may desire or require that the position adjuster 120 and D-ring 176 be adjusted to a low position in the vehicle.

Adjustments to the position on the track 152 of the seatbelt position adjuster 120 may be performed manually, by depressing the release mechanism 174 and manually sliding the position adjuster to the desired position along the track. As shown in FIGS. 2A and 2B, the track 152 may include a stop piece 184 that limits downward adjustments of the position adjuster 120. When the position adjuster 120 reaches the desired position, the release mechanism 174 is released, which releases the latch member 172. The latch member 172 is then urged into an adjacent aperture 154 under the bias of the biasing member. The latch member 172 engages the aperture 154 and blocks further movement of the position adjuster 120 along the length of the track 152 and maintains the seatbelt 100 at the desired height.

The curtain anchor 60 includes a body portion 190 that is secured to the track 152 and is adapted for sliding movement along the length of the track. The sliding relationship between the curtain anchor 60 and track 152 may be achieved by any known manner. For example, referring to FIG. 2C, the track 152 may include slots 188 that extend along the length of the track. In this example, the body portion 190 may have portions (not shown) that extend into or through the slots 188 and thereby support the curtain anchor 60 for sliding movement along the track 152.

The curtain anchor 60, track 152, or both may be fitted with bearing surfaces that facilitate a smooth sliding engagement. As shown in FIG. 2B, the body portion 190 may be positioned for sliding movement on the inner surface 182 of the track 152. As shown in FIG. 2A, the body portion 190 may also have a portion positioned on an outer surface of one of the side walls 162.

The curtain anchor 60 also includes a latch element or member 194 that protrudes from a surface of the body portion 190 facing the inner surface 182 of the track 152. The latch member 194 is biased to the position shown in FIG. 2B by means (not shown), such as a spring. The latch member 194 has a cam surface 200 that extends at an angle to the inner surface 182 of the track 152 and is presented facing generally downward as viewed in FIG. 2B. A latch surface 202 extends generally perpendicular to the inner surface 182 of the track 152. The cam surface 200 is operative to cause the latch member 194 to retract into the body portion 190 against the spring bias when a downward force urges the cam surface against an edge of the track surrounding an aperture 154 in which the latch member 194 is positioned.

The curtain anchor 60 further includes a curtain ring or loop 204 for helping to connect the inflatable curtain 14 to the anchor. The inflatable curtain 14 may be connected directly to the curtain ring 204 or could be connected to the ring by the tether 62, as shown in FIGS. 2A and 2B.

Upon inflation and deployment of the inflatable curtain 14, the curtain 14 pulls on the curtain anchor 60 via the tether 62. The inflating curtain 14 causes the curtain anchor 60 to slide along the track 152 in a direction downward as viewed in FIG. 1 away from the vehicle roof 18. Referring to FIGS. 2A and 2B, as the body portion 190 slides downward along the track 152, the latch member 194 slides along and is biased against the inner surface 182. When the latch member 194 reaches an aperture 154, the member is biased into the aperture.

When the latch member 194 is positioned in an aperture 154, further downward movement of the member causes the cam surface 200 to engage an edge of the track 152 surrounding the aperture. The cam surface 200 rides on the edge, which causes the latch member 194 to retract out of the aperture 154. The curtain anchor 60 may thus slide downward along the track 152 in a relatively unrestricted manner.

Movement of the curtain anchor 60 in an upward direction as viewed in FIGS. 1-2B is prevented by the latch member 194. Upward movement of the curtain anchor 60 causes the latch surface 202 to engage the edge of the track 152 surrounding the aperture 154. The engagement between the latch surface 202 and this edge blocks upward movement of the anchor 60 along the track 152.

From the above, it will thus be appreciated that the latch member 194 permits movement of the curtain anchor 60 in the downward direction and blocks movement of the anchor in the upward direction. The curtain anchor 60 and tether 62 help maintain the inflatable curtain 14 in the inflated and deployed position. The curtain anchor 60 also helps to limit movement of the inflatable curtain 14 away from the inflated and deployed position illustrated in FIG. 1.

As a feature of the present invention, the apertures 154 provide various positions along the length of the track 152 where the curtain anchor 60 is blocked from moving in the upward direction. Thus, as the curtain anchor 60 slides downward along the track 152, it is blocked from moving in the upward direction at the farthest downward position reached along the track. This feature is a benefit, for example, in a side impact or rollover event if the track 152 is deformed by impact forces such that the curtain anchor 60 is prevented from moving in the downward direction along the track 152.

As another feature of the present invention, the use of a single track 152 for supporting the curtain anchor 60 and seatbelt position adjuster 120 may help reduce the amount of space required for installation of these components in the vehicle 12. To further this point, it will be appreciated that, in the embodiment of FIGS. 2A-2C, the curtain anchor 60 and position adjuster 120 both make use of the same row of apertures 154. As shown in FIG. 2B, the latch member 172 of the position adjuster 120 has a rounded terminal end portion 210 that projects through the aperture 154 into the channel 164. In the event that the inflatable curtain 14 inflates and deploys, the cam surface 200 can slide over the end portion 210, deflecting the latch member 194 into the body portion 190 and allowing the curtain anchor 60 to slide unimpeded past the position adjuster 120. The curtain anchor 60 and the position adjuster 120 can thus share the same track 152 and the same apertures 154 without interfering with or negatively affecting each other's operation.

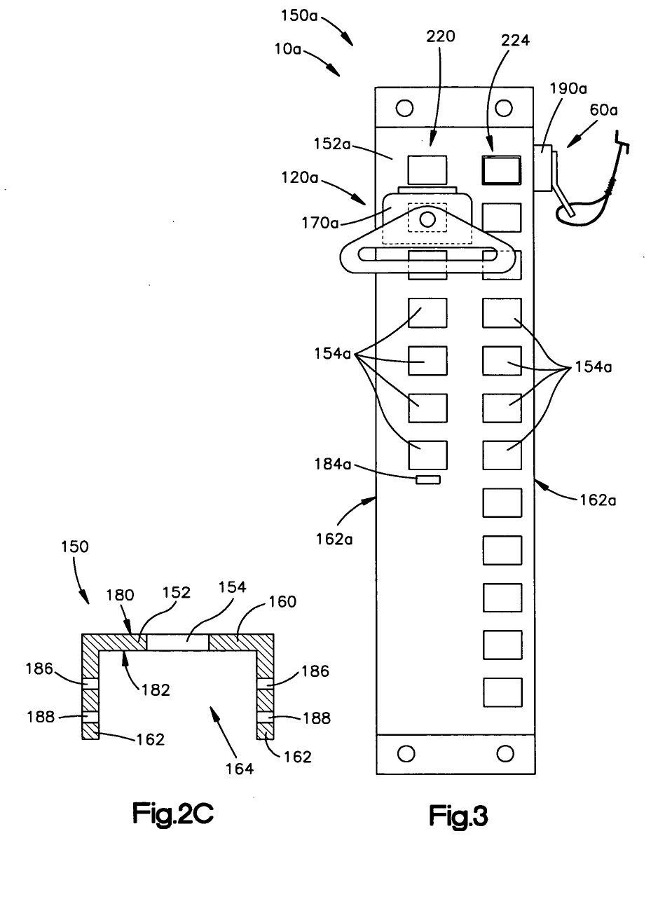

A second embodiment of the present invention is illustrated in FIG. 3. The second embodiment of the invention is similar to the first embodiment of the invention illustrated in FIGS. 1-2C. Accordingly, numerals similar to those of FIGS. 1-2C will be utilized in FIG. 3 to identify similar components, the suffix letter “a” being associated with the numerals of FIG. 3 to avoid confusion.

The apparatus 10a of the embodiment shown in FIG. 3 is similar to the apparatus of the embodiment shown in FIGS. 1-2C. In the embodiment of FIG. 3, the track assembly 150a includes a track 152a with two rows of apertures 154a. A first row 220 of apertures 154a is dedicated to the seatbelt position adjuster 120a and a second row 222 of apertures is dedicated to the curtain anchor 60a. Since the rows 220 and 222 are dedicated to the position adjuster 120a and curtain anchor 60a, respectively, it will be appreciated that the apertures 154a of the first row need extend down only to the stop piece 184a.

The seatbelt position adjuster 120a and curtain anchor 60a may be similar or identical in configuration to those of the first embodiment, with the exception of any changes or adjustments to their configurations brought about by the altered configuration of the track 152a. For example, in the first embodiment, the body portions 170 and 190 are adapted to ride in slots 186 and 188, respectively, in the opposing side walls 162 of the track 152. In the second embodiment, however, since the apertures 154a are in separate rows, one or both of the body portions 170a and 190a may ride in a slot in one of the side walls 162a only.

From the above description of the invention, those skilled in the art will perceive improvements, changes and modifications. Such improvements, changes and modifications within the skill of the art are intended to be covered by the appended claims.

Having described the invention, the following is claimed:

1. An apparatus for a vehicle having a seatbelt and an inflatable vehicle occupant protection device, said apparatus comprising:
a track connectable with the vehicle;
a protection device anchor for helping to maintain the position of the inflatable vehicle occupant protection device while inflated, said protection device anchor being movable along said track in response to deployment of the inflatable vehicle occupant protection device; and
a seatbelt position adjuster associated with the seatbelt and movable along said track to adjust a position of a portion of the seatbelt.

2. The apparatus recited in claim 1, wherein said protection device anchor is connectable with a tether associated with the inflatable vehicle occupant protection device.

3. The apparatus recited in claim 1, wherein said protection device anchor is movable along the track in a first direction in response to inflation of the inflatable vehicle occupant protection device, said protection device anchor being blocked from movement in a second direction opposite the first direction.

4. The apparatus recited in claim 3, wherein said track comprises a plurality of apertures and said protection device anchor comprises a latch member for engaging said apertures, said latch member being adapted to permit said protection device anchor to move in said first direction and to engage said apertures to block movement of said protection device anchor in said second direction.

5. The apparatus recited in claim 1, wherein said position adjuster comprises a ring through which seatbelt webbing of the seatbelt passes.

6. The apparatus recited in claim 1, wherein said track comprises a plurality of apertures and said position adjuster comprises a latch member for engaging said apertures and blocking movement of said position adjuster along said track.

7. The apparatus recited in claim 6, wherein said position adjuster further comprises a release mechanism actuatable to permit said movement of said position adjuster along said track.

8. The apparatus recited in claim 1, wherein said track is connectable to a side structure of the vehicle.

9. The apparatus recited in claim 1, wherein said track is connectable to a pillar of the vehicle.

10. An apparatus for a vehicle having a seatbelt and an inflatable vehicle occupant protection device, said apparatus comprising:
a track connectable with the vehicle;
a first element movable along said track and adapted to engage said track to help limit movement of the inflatable vehicle occupant protection device relative to the vehicle; and
a second element movable along said track and adapted to engage said track to help fix the height of the seatbelt.

11. The apparatus recited in claim 10, wherein said first element is movable along said track in response to deployment of the inflatable vehicle occupant protection device.

12. The apparatus recited in claim 10, wherein said second element is movable along said track in response to a manual adjustment of the position of the second element.
